(19) United States
(12) Patent Application Publication
(10) Pub. No.: US 2026/0230013 A1
(43) Pub. Date: Aug. 6, 2026

(54) Motor Control Device

(71) Applicant: Astemo, Ltd., Chiyoda-ku, Tokyo (JP)

(72) Inventors: Toshisada MITSUI, Hitachinaka-shi, Ibaraki (JP); Hirokazu MATSUI, Hitachinaka-shi, Ibaraki (JP); Yuichiro TAKAMUNE, Hitachinaka-shi, Ibaraki (JP)

(21) Appl. No.: 19/149,908

(22) PCT Filed: Jan. 25, 2023
(86) PCT No.: PCT/JP2023/002207

§ 371 Date: Jul. 22, 2025

(51) Int. Cl. H02P 6/16; H02P 27/08

(52) U.S. Cl. CPC H02P 6/16; H02P 27/08; H02P 2209/11

(57) ABSTRACT

Provided is a vehicle control device 21 capable of automatically starting quiet electric travel when a hybrid vehicle approaches a base without a driver performing a switching operation or setting a destination for a navigation device when the hybrid vehicle travels near the base. The vehicle control device 21 is mounted on a vehicle 100 that switches between a first travel state in which the driving force of an electric motor 107 due to power being supplied from a battery 105 is transmitted to a driving wheel 109 to drive the vehicle 100, and a second travel state in which the vehicle 100 is driven with the operation of an engine 102. The vehicle control device 21 includes: a determination value storage unit 27 that, for each of a plurality of predetermined sites, assigns and stores a determination value obtained from a battery consumption amount required for the vehicle 100 to travel in the first travel state from a predetermined point to bases 31, 31A and 31B and obtained from a target battery remaining amount at the time of arrival at the bases 31, 31A, and 31B; and a travel state determination unit 28 that starts the travel in the first travel state in a case where the current battery charge amount of the vehicle 100 exceeds a determination value corresponding to the current location of the vehicle 100.

### TECHNICAL FIELD

The present invention relates to a motor control device.

### BACKGROUND ART

In recent years, with the electrification of automobiles, vehicles in which a motor (electric motor) is applied to a main machine and auxiliaries (brakes, power steering, and the like) have become widespread, and highly accurate rotation angle detection is required to control the motor with high accuracy.

PTL 1 describes a bearing with a rotation sensor capable of detecting an absolute angle.

With the technique described in PTL 1, it is possible to perform measurement in advance when a bearing is manufactured, record error correction data in a component equipped with a correction data recording unit, and detect an absolute angle without calibration work after the bearing is installed.

PTL 2 discloses a motor drive device that reduces a speed ripple while maintaining the reproducibility of position information of a movable element of the motor drive device.

According to the technique described in PTL 2, an ellipse parameter indicating an ellipse approximate to a Lissajous curve based on two sinusoidal signals with shifted phases which are outputted from the movable element of the motor drive device is calculated. The two sinusoidal signals are then corrected so that the ellipse becomes a new circle, and the motor drive device is controlled based on the speed information indicating the movement speed of the movable element with the Lissajous figure based on the two corrected sinusoidal signals.

### CITATION LIST

### Patent Literature

PTL 1: JP 2004-353683 A
PTL 2: JP 2011-125073 A

### SUMMARY OF INVENTION

### Technical Problem

Here, in order to reduce costs, it is necessary to perform phase detection via a general-purpose analog-to-digital converter (ADC) as a motor angle sensor.

The general-purpose ADC has a temperature characteristic, and thus distortion of AD values occurs over time. For this AD value distortion, it is conceivable to use a calibration function of the ADC for each AD value channel.

However, because it takes a certain amount of time to calibrate the AD value, it is possible to perform calibration when the motor is powered on, but it is difficult to perform calibration while the motor is driven.

PTL 1 and PTL 2 do not disclose a technique enabling calibration of AD values of a general-purpose ADC even while the motor is being driven.

An object of the present invention is to realize a motor control device enabling calibration of AD values of a general-purpose ADC to be executed even while a motor is being driven, thus enabling improvement in the accuracy of detection of the rotational electrical angle of the motor.

### Solution to Problem

In order to achieve the above object, the present invention is configured as follows.

A motor control device has a power conversion unit that converts DC power into three-phase AC power and outputs the converted three-phase AC power to a motor, a rotation angle sensor that detects the phase of the motor, and an AD converter that converts an analog signal outputted from the rotation angle sensor into a digital signal, the motor control device comprising a rotational-position detection unit that includes: a recording unit that records a plurality of sets of data which includes a sine wave signal and a cosine wave signal of the phase of the motor which are included in the digital signal; a calibration necessity determination unit that determines, on the basis of the plurality of sets of data, whether or not calibration of the phase of the motor is required; and an elliptical approximation unit that, in a case where calibration of the phase of the motor is required, performs elliptical approximation on the basis of the plurality of sets of data and calculates an elliptical constant; a calibration unit that calibrates the sine wave signal and the cosine wave signal on the basis of the elliptical constant; and a phase computation unit that computes the phase on the basis of the sine wave signal and the cosine wave signal calibrated by the calibration unit, wherein the plurality of sets of data are distributed to a predetermined number of divided regions spanning one or more electrical angle cycles.

### BRIEF DESCRIPTION OF DRAWINGS

FIG. 1 is an overall configuration diagram of a motor control device according to a first embodiment.

FIG. 2 is an internal configuration diagram of a rotational-position detection unit 400 of the motor control device according to the first embodiment.

FIG. 3A is an explanatory diagram of an internal configuration of an array buffer.

FIG. 3B is an explanatory diagram of an internal configuration of an array buffer.

FIG. 3C is an explanatory diagram of an internal configuration of an array buffer.

FIG. 3D is an explanatory diagram of an internal configuration of an array buffer.

FIG. 4 is an explanatory diagram of an internal configuration of an array buffer.

FIG. 5A is a diagram illustrating an ellipse in a case where there is no offset at the origin.

FIG. 5B is a diagram illustrating a perfect circle in a case where there is an offset at the origin.

FIG. 6 is a diagram illustrating a memory of an origin distance.

FIG. 7 is an internal configuration diagram of a calibration unit.

FIG. 8 is an internal configuration diagram of a rotational-position detection unit according to a second embodiment.

FIG. 9 is a diagram showing an arrangement configuration of data stored in an arrangement buffer according to the second embodiment.

FIG. 10 is a diagram explaining the operation of an elliptical approximation unit according to the second embodiment.

FIG. 11A is a diagram illustrating a series (waveform line) of a constant a′.

FIG. 11B is a diagram illustrating a series (waveform line) of a constant b′.

FIG. 12 is a functional block diagram of an elliptical approximation unit 430 according to the second embodiment.

FIG. 13 is a diagram illustrating an ideal sine wave signal and a cosine wave signal of an ADC (analog/digital converter).

FIG. 14 is a schematic diagram illustrating a sine wave signal and a cosine wave signal in a case where, although a median value is fixed, the amplitudes of the sine wave signal and the cosine wave signal fluctuate.

FIG. 15 is an explanatory diagram of an elliptical orbit.

### DESCRIPTION OF EMBODIMENTS

Prior to the description of the embodiments of the present invention, the principle behind the present invention will be described.

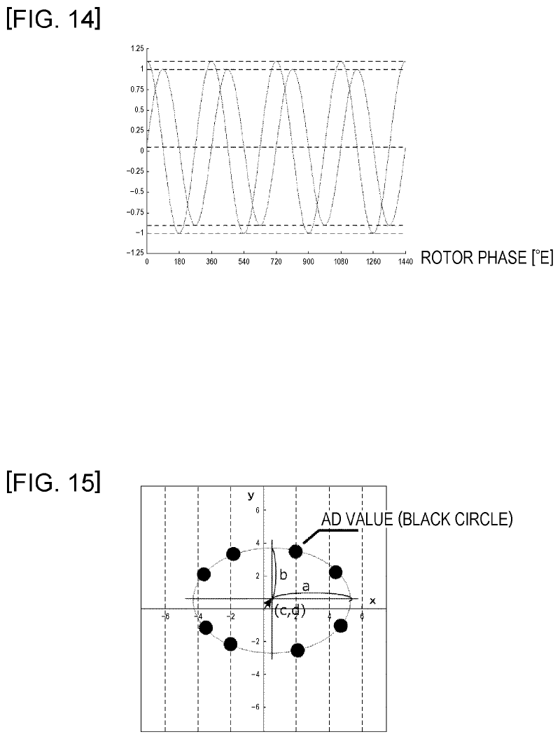

FIG. 13 is a diagram illustrating an ideal sine wave signal and a cosine wave signal of an ADC (analog/digital converter). Where the detection of the electrical angle of an electric motor is concerned, there are three electrical-angle error factor potentials.

The first error factor is a conversion error due to the temperature characteristic of the ADC. Although the ADC has an error calibration function, the function takes processing time and thus cannot be used while the electric motor is being driven.

The second error factor is an error due to a performance variation of the interface (I/F) of the input circuit of the ADC.

The third error factor is an error derived from the machining accuracy of the resolver.

Although the median value of the first error factor and the second error factor is fixed, the amplitudes of the sine wave signal and the cosine wave signal fluctuate, which causes disturbance. This causes the disturbance to be repeated for every one electrical angle cycle. This i defined as “distortion”. FIG. 14 is a schematic diagram illustrating the sine wave signal and the cosine wave signal in a case where, although the median values are fixed, the amplitudes of the sine wave signal and the cosine wave signal fluctuate. However, FIG. 14 highlights the fluctuations for the sake of understanding.

The third error factor causes the amplitude and the median to fluctuate over one mechanical angle cycle. The third error factor is a variation in the median value in addition to the variation in the amplitude illustrated in FIG. 14, and both variations occur simultaneously. Therefore, the entire waveform of the fluctuating amplitude pulsates. This is defined as “fluctuation”.

Distortion due to the “distortion” and the “fluctuation” directly leads to the occurrence of an error in the rotation angle and causes torque fluctuations.

The present invention is capable of eliminating the distortion, suppressing torque fluctuation, and stabilizing control.

That is, a sine wave signal including distortion (distorted sine wave signal) can be expressed as y=a·sin(θ)+c, and a cosine wave signal including distortion (distorted cosine wave signal) can be expressed as x=b·cos (θ)+d. a and b represent amplitude fluctuations, and c and d represent median fluctuations.

Here, when cos² θ+sin² θ=1 is used, it is understood that the distorted sine wave signal y and the distorted cosine wave signal x draw an elliptical orbit represented by (x−c)²/a²+(y−d)²/b²=1 as illustrated in FIG. 15. In this ellipse, the major axis and the minor axis are parallel to the x-axis and the y-axis.

Therefore, elliptical constants (a, b, c, d) can be determined by collecting a plurality of sets of (xi, yi) and performing elliptical approximation by the least squares method. The calibration processing becomes a·cos θ by subtracting c from cosine wave signal y, and can be restored to cos θ by further dividing a·cos θ by a. The same applies to the sine wave signal y.

By performing the processing as described above, it is possible to obtain a (cos θ, sin θ) which draws a perfect circle and to eliminate distortion.

It is also possible to ascertain connections between elliptical constants by repeating the elliptical approximation for a set of (xi, yi) for one mechanical angle cycle, and cancel distortion by performing calibration in the same manner as distortion.

According to the principles of the present invention, it is possible to eliminate rotation angle errors and eventually eliminate ripples in speed, suppress torque fluctuations, and stabilize control.

Hereinafter, embodiments of the motor control device according to the present invention will be described with reference to the drawings. Note that, in the drawings, the same elements are denoted by the same reference signs, and thus redundant descriptions thereof will be omitted.

### EMBODIMENTS

### First Embodiment

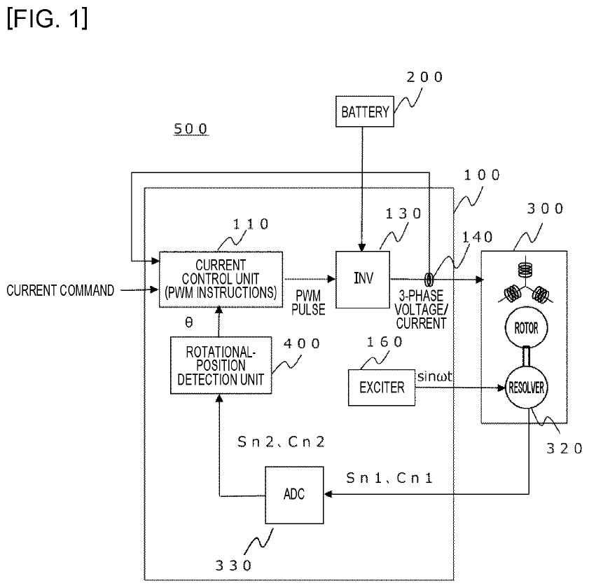

FIG. 1 is a diagram illustrating a configuration of a motor control device 500 constituting a first embodiment of the present invention.

The motor control device 500 illustrated in FIG. 1 is configured for the purpose of calibrating distortion of AD values caused by the temperature of an ADC 330 in particular and calibrating errors of the I/F circuit.

The motor control device 500 includes a motor 300, a motor drive device 100, and a rotational-position detection unit 400. The motor drive device 100 includes a current control unit 110, an inverter (power converter) 130, the rotational-position detection unit 400, an excitation unit 160, and the ADC 330. The battery 200 is a DC voltage source of the motor drive device 100. The DC power stored in the battery 200 is converted into three-phase AC power of variable voltage and variable frequency by the inverter 130 of the motor drive device 100. The inverter 130 supplies the three-phase AC power to the motor 300.

The motor 300 is a synchronous motor rotationally driven by supplying three-phase AC power. A resolver 320 is attached to the motor 300 as a rotation angle sensor in order to control the phases of a three-phase AC voltage in accordance with the phases of the induced voltages of the motor 300.

The resolver 320 receives an excitation signal (sin ωt) from the excitation unit 160, and outputs amplitude-modulated two-phase signals Sn1, Cn1, the phases of which are shifted from each other by 90°, to an ADC (AD converter) 330 (θ is the rotation angle of the motor). The ADC 330 converts the analog signal outputted from the resolver (rotation angle sensor) 320 into a digital signal. The current control unit 110 calculates motor current values (Iu, Iv, Iw) detected by the current sensor 140 so as to follow a current command value created by a host control device (not illustrated), and a three-phase motor voltage command value according to a rotation angle θ of the motor detected by a rotational-position detection unit 150 (described below). The current control unit 110 then creates a drive signal created by pulse width modulation (PWM) and outputs the drive signal to the inverter 130.

The semiconductor switch element constituting the main circuit in the inverter 130 is controlled to be turned on/off by the drive signal outputted from the current control unit 110. The inverter 130 outputs three-phase voltages (Vu, Vv, Vw) to the motor 300 according to the motor voltage command value.

The ADC 330 constituting the analog/digital converter detects the excitation signal (sin ωt) from the two output signals (Sn1 (sin θ sin ωt) and Cn1 (cos θ sin ωt)) from the resolver 320. The ADC 330 then outputs, as a set, a sine wave signal (sine wave component) Sn2 and a cosine wave signal (cosine wave component) Cn2, which are digital values in the form (sin θ, cos θ) to the rotational-position detection unit 400.

The set of the sine wave signal Sn2 and the cosine wave signal Cn2 is actually distorted as (a·sin θ+c, b·cos θ+d). As described below, the rotational-position detection unit 400 calculates the rotation angle θ of the motor by calibrating the sine wave signal Sn2 and the cosine wave signal Cn2.

FIG. 2 is an internal configuration diagram of the rotational-position detection unit 400. In FIG. 2, an array buffer (recording unit) 410 stores (records) a plurality of sets of data including the sine wave signal Sn2 and the cosine wave signal Cn2 from the ADC 330. The calibration necessity determination unit 420 determines the data stored in the array buffer 410 (determines whether or not to correct the phase of the electric motor 300 on the basis of the plurality of sets of data) and transmits a necessity result signal Sig1 to the elliptical approximation unit 430.

In a case where the calibration necessity is instructed by the necessity result signal Sig1, the elliptical approximation unit 430 performs elliptical approximation on the basis of the data stored in the array buffer unit 410 and calculates a set of elliptical constants (a, b, c, d).

A calibration unit 440 calibrates sine wave signal Sn2 and cosine wave signal Cn2 outputted from the ADC 330 so as to plot a true circular orbit by using the set (a, b, c, d) of the elliptical constants outputted from the elliptical approximation unit 430. The calibration unit 440 then outputs a perfect-circle sine wave signal Sn3 and cosine wave signal Cn3 to a motor rotation angle computation unit 450. In FIG. 2, the motor rotation angle computation unit 450 is indicated as a tan 2.

The motor rotation angle computation unit (phase computation unit) 450 calculates the motor rotation angle θ from the sine wave signal Sn3 and the cosine wave signal Cn3 outputted from the calibration unit 440 (calculates the phase on the basis of sine wave component Sn2 and cosine wave component Cn2 calibrated by the calibration unit 440).

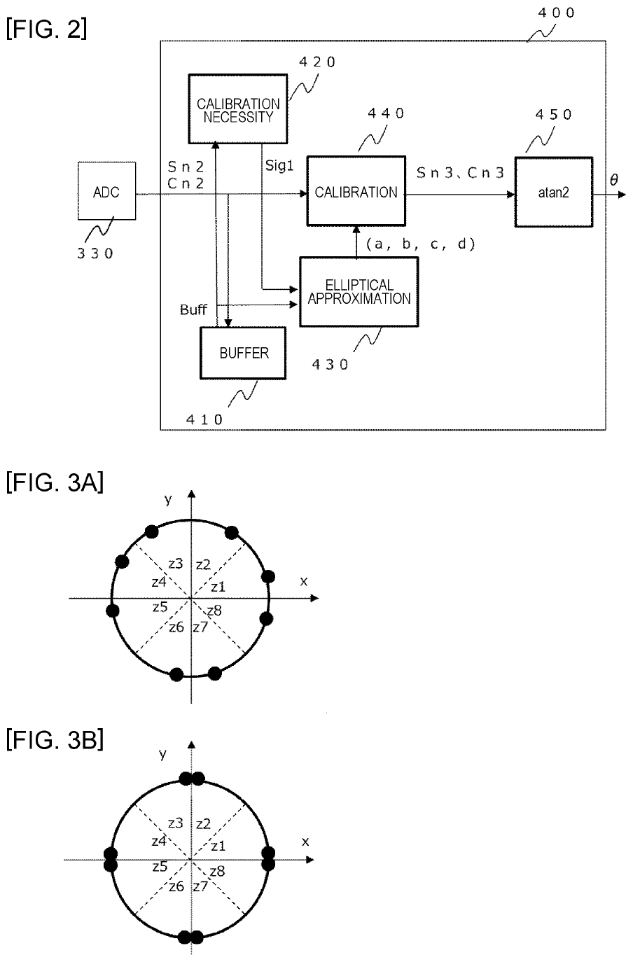

FIGS. 3A to 3D and FIG. 4 are explanatory diagrams of an internal configuration of the array buffer 410.

In order to perform elliptical approximation, at least four sets of sine wave signals Sn2 and cosine wave signals Cn2 are required. Hereinafter, this is referred to as sets of data.

Therefore, the motor rotation angle range of 0° to 360° is divided into 8 zones, and sets of data is collected. It is assumed that each zone zi is z1, z2, . . . , z8. FIG. 3A is a plot of a state where sine wave signal Sn2 is set to a y coordinate and cosine wave signal Cn2 is set to an x coordinate in zone zi. By collecting sets of data as illustrated in FIG. 3A, at least four pieces of valid data can be secured even if data aggregation occurs in a total of four places, that is, two places on the x-axis and two places on the y-axis, as illustrated in FIG. 3B. Therefore, it is sufficient to determine only the satisfaction of the data of eight zones, and it is easy to determine the completion of the data collection. That is, it is possible to prepare a set of data in which the angular range is appropriately separated over 0 to 360°.

In addition, FIG. 3C illustrates an example in which the sets of data is collected at the boundary end between the zone z1 and the zone z2, the boundary end between the zone z3 and the zone z4, the boundary end between the zone z5 and the zone z6, and the boundary end between the zone z7 and the zone z8. From these sets of data, two ellipses can be assumed as illustrated in FIG. 3C, and thus the ellipses are not defined.

Therefore, as illustrated in FIG. 3D, it is better to tilt the boundary line (indicated by the broken lines) of each zone zi by an appropriate angle βx to intentionally shift the x coordinate and the y coordinate of the boundary end.

That is, the elliptical approximation unit 430 extracts a plurality of consecutive sets of data from the sets of data spanning the mechanical angle, performs partial elliptical approximation to obtain a partial elliptical constant, slides the partial elliptical approximation to perform elliptical approximation spanning the entire mechanical angle, and obtains connections between elliptical constants spanning the entire mechanical angle. The elliptical approximation can be performed by making the boundary points of the dividing lines of each zone zi irregular.

As described above, in the array buffer 410, the sets of data are collected in the array buffer 410 corresponding to the determined zone zi for the purpose of zone determination.

Although an example in which a motor rotation angle range of 0° to 360° is divided into 8 zones will be described below, the motor rotation angle range of 0° to 360° may be equally divided into 8 or more zones (can be divided into at least 8 regions, and is divisible into 8 to 32 zones, for example).

FIG. 4 is a diagram illustrating a data array in the array buffer 410. For the zones z1 to z8, data ((y1, x1) to (y8, x8)) of a sine wave signal Sn2i and a cosine wave signal Cn2i are arranged.

Next, the calibration necessity determination unit 420 will be described.

Using the data ((y1, x1) to (y8, x8)) of the sine wave signal Sn2i and the cosine wave signal Cn2i, the calibration necessity determination unit 420 determines the necessity for calibration by examining the difference between a maximum value and a minimum value for the distance (origin distance) Ri from the origin, that is, the amplitude. The origin distance Ri is obtained by calculating the square root of (xi²+yi²). Note that i is a variable and, in the first embodiment, is a number from 1 to 8.

As illustrated in FIG. 6, the calculated origin distance Ri can be stored in an appropriate memory (for example, the memory in the calibration necessity determination unit 420) to determine the amplitude.

First, in a case where there is a perfect circle and no offset of the origin, each origin distance Ri is a radius of the circle and is constant, there is no difference between the maximum value and the minimum value, and the amplitude is zero.

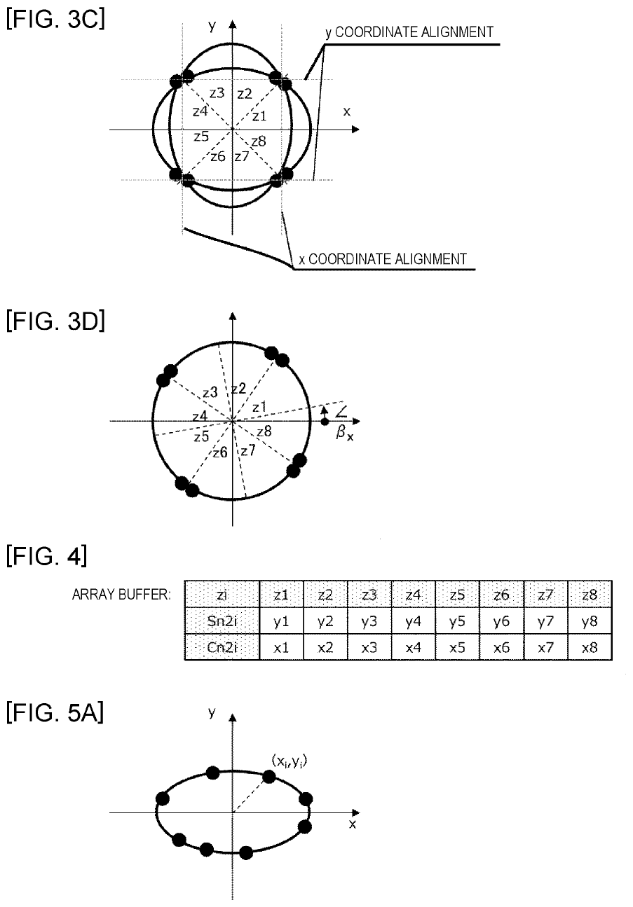

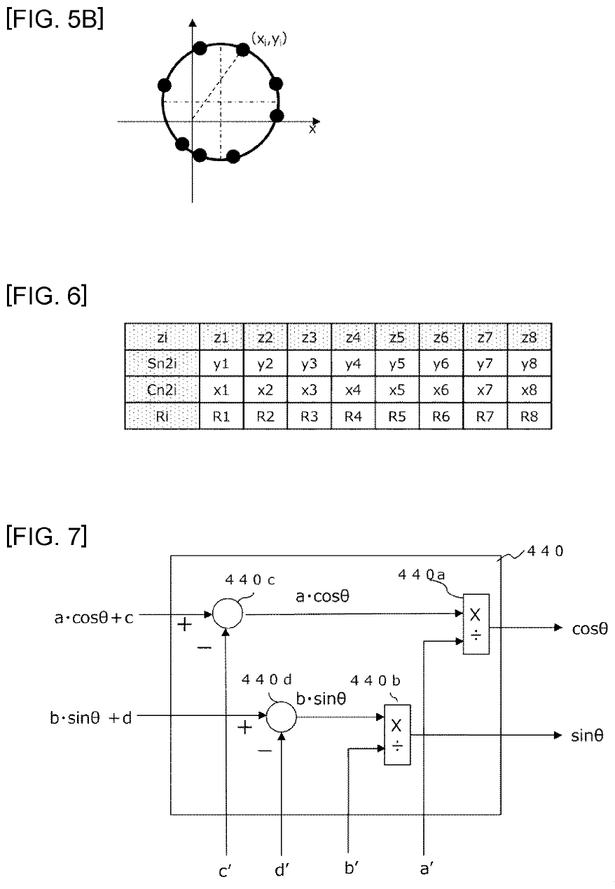

Second, in a case where there is an ellipse but no offset of the origin (in the case of the ellipse shown in FIG. 5A), the origin distance Ri has two waves between the angles of 0 to 360° due to the presence of the major axis and the minor axis, and the amplitude occurs between the maximum value and the minimum value of the origin distance Ri.

Third, in a case where there is a perfect circle but the origin is offset (in the case illustrated in FIG. 5B), the origin distance Ri has one wave between the angles of 0 to 360°, and similarly to the example illustrated in FIG. 5A, the amplitude occurs between the maximum value and the minimum value of the origin distance Ri.

In this manner, it is possible to determine whether calibration is necessary from the amplitude of the origin distance Ri.

That is, it can be determined that calibration is necessary in a case where the amplitude of the origin distance Ri exceeds a predetermined value, and it can be determined that calibration is not necessary in a case where the amplitude of the origin distance Ri does not exceed the predetermined value.

The calibration necessity determination unit 420 outputs the calibration necessity determination result to the elliptical approximation unit 430 as the necessity result signal Sig1.

Next, the operation of the elliptical approximation unit 430 will be described.

In the elliptical approximation, the constants (a, b, c, d) are determined by the least squares method using the data of a plurality of pieces of data (xₖ, yₖ).

For elliptical approximation, elliptical expressions are rearranged as the following expressions (1) to (4).

$$[ Equation 1 ]$$

$$\frac{{( x - c )}^{2}}{{a}^{2}} + \frac{{( y - d )}^{2}}{{b}^{2}} = 1 \qquad ( 1 )$$

$$[ Equation 2 ]$$

$$\begin{matrix} & \\ ( x - c ) 2 + \frac{{a}^{2}}{{b}^{2}} \cdot ( y - d ) 2 = {a}^{2} & ( 2 )\end{matrix}$$

$$\begin{matrix}[ Equation 3 ] & \\ {x}^{2} - 2 c \cdot x + {c}^{2} + \frac{{a}^{2}}{{b}^{2}} \cdot ( {y}^{2} - 2 d \cdot y + {d}^{2} ) - {a}^{2} = 0 & ( 3 )\end{matrix}$$

$$\begin{matrix}[ Equation 4 ] & \\ {x}^{2} + A \cdot {y}^{2} + B \cdot x + C \cdot y + D = 0 & ( 4 )\end{matrix}$$

Parameters are determined according to the following general minimum approximation steps Step 1 to Step 3.

Step 1. The following expression (5) is used to formulate an evaluation expression.

$$\begin{matrix}[ Equation 5 ] & \\ G = {\sum }_{k} {\{ {x}^{2} + A \cdot {y}^{2} + B \cdot x + C \cdot y + D \}}^{2} = 0 & ( 5 )\end{matrix}$$

Step 2. The evaluation expression is partially differentiated by the following expressions (6(6-1 to 6-4)) with the parameters (A, B, C, D) to be obtained.

$$\begin{matrix}[ Equation 6 ] & \\ \partial G / \partial A = A \cdot Σ ( {y}^{4} ) + Σ ( {x}^{2} \cdot {y}^{2} ) + B \cdot Σ ( x \cdot {y}^{2} ) + C \cdot Σ ( {y}^{3} ) + D \cdot Σ ( {y}^{2} ) = 0 & ( 6 - 1 )\end{matrix}$$

$$\partial G / \partial B = B \cdot Σ ( {x}^{2} ) + Σ ( {x}^{3} ) + A \cdot Σ ( x \cdot {y}^{2} ) + C \cdot Σ ( x \cdot y ) + D \cdot Σ ( x ) = 0 \qquad ( 6 - 2 )$$

$$\partial G / \partial C = C \cdot Σ ( {y}^{2} ) + Σ ( {x}^{2} \cdot y ) + A \cdot Σ ( {y}^{3} ) + B \cdot Σ ( x \cdot y ) + D \cdot Σ ( y ) = 0 \qquad ( 6 - 3 )$$

$$\partial G / \partial D = D \cdot Σ ( 1 ) + Σ ( {x}^{2} ) + A \cdot Σ ( {y}^{2} ) + B \cdot Σ ( x ) + C \cdot Σ ( y ) \qquad ( 6 - 4 )$$

Step 3. Perform matrixing and determine parameters as in the following expression (7).

$$\begin{matrix}[ Equation 7 ] & \\ [ \begin{matrix}Σ ( {y}^{4} ) & Σ ( x \cdot {y}^{2} ) & Σ ( {y}^{3} ) & Σ ( {y}^{2} ) \\ Σ ( x \cdot {y}^{2} ) & Σ ( {x}^{2} ) & Σ ( x \cdot y ) & Σ ( x ) \\ Σ ( {y}^{3} ) & Σ ( x \cdot y ) & Σ ( {y}^{2} ) & Σ ( y ) \\ Σ ( {y}^{2} ) & Σ ( x ) & Σ ( y ) & Σ ( 1 )\end{matrix} ] \cdot [ \begin{matrix}A \\ B \\ C \\ D\end{matrix} ] = [ \begin{matrix}- Σ ( {x}^{2} \cdot {y}^{2} ) \\ - Σ ( {x}^{3} ) \\ - Σ ( {x}^{2} \cdot y ) \\ - Σ ( {x}^{2} )\end{matrix} ] & ( 7 )\end{matrix}$$

Then, the parameters (A, B, C, D) are obtained by the following expression (8), and elliptical constants (a, b, c′, d′) are determined by the following expressions (9-1) to (9-4).

$$\begin{matrix}[ Equation 8 ] & \\ [ \begin{matrix}A \\ B \\ C \\ D\end{matrix} ] = {[ \begin{matrix}Σ ( {y}^{4} ) & Σ ( x \cdot {y}^{2} ) ) & Σ ( {y}^{3} ) & Σ ( {y}^{2} ) \\ Σ ( x \cdot {y}^{2} ) & Σ ( {x}^{2} ) & Σ ( x \cdot y ) & Σ ( x ) \\ Σ ( {y}^{3} ) & Σ ( x \cdot y ) & Σ ( {y}^{2} ) & Σ ( y ) \\ Σ ( {y}^{2} ) & Σ ( x ) & Σ ( y ) & Σ ( 1 )\end{matrix} ]}^{- 1} \cdot [ \begin{matrix}- Σ ( {x}^{2} \cdot {y}^{2} ) \\ - Σ ( {x}^{3} ) \\ - Σ ( {x}^{2} \cdot y ) \\ - Σ ( {x}^{2} )\end{matrix} ] & ( 8 )\end{matrix}$$

$$\begin{matrix}[ Equation 9 ] & \\ {c}^{′} = - B / 2 & ( 9 - 1 )\end{matrix}$$

$${d}^{′} = - C / A / 2 \qquad ( 9 - 2 )$$

$${a}^{′} 2 = - D + {c}^{′2} + {d}^{′2} * A \qquad ( 9 - 3 )$$

$${b}^{′2} = {a}^{′2} / A \qquad ( 9 - 4 )$$

A dash is added to an elliptical constant to indicate an approximate value.

The above processing is executed if the necessity result signal Sig1 indicates that calibration is necessary, and no processing is executed if calibration is not necessary.

Next, the calibration unit 440 will be described.

FIG. 7 is an internal configuration diagram of the calibration unit 440. Distortion occurs in the sine wave signal Sn2 and the sine wave signal Cn2 outputted by the ADC 330. That is, as shown in the following expressions (10) and (11), the signals can be expressed as signals x and y including distortion.

$$\begin{matrix}[ Equation 10 ] & \\ x = a \cdot cos θ + c & ( 10 )\end{matrix}$$

$$\begin{matrix}[ Equation 11 ] & \\ y = b \cdot sin θ + d & ( 11 )\end{matrix}$$

A subtractor 440c of the calibration unit 440 removes the offset of the signal x, and a subtractor 440d removes the offset of the signal y. These are expressed by the following expressions (12) and (13).

$$\begin{matrix}[ Equation 12 ] & \\ x - {c}^{′} = a \cdot cos θ + ( c - {c}^{′} ) & ( 12 )\end{matrix}$$

$$\begin{matrix}[ Equation 13 ] & \\ y - {d}^{′} = b \cdot sin θ + ( d - {d}^{′} ) & ( 13 )\end{matrix}$$

Here, c-c′=0 and d-d′=0 may be considered, and can be expressed, by the following expressions (14) and (15).

$$\begin{matrix}[ Equation 14 ] & \\ x - {c}^{′} = a \cdot cos θ & ( 14 )\end{matrix}$$

$$\begin{matrix}[ Equation 15 ] & \\ y - {d}^{′} = b \cdot sin θ & ( 15 )\end{matrix}$$

Next, the amplitudes are equalized by multiplication/division machines 440a and 440b. That is, the following expressions (16) and (17) are performed.

$$\begin{matrix}[ Equation 16 ] & \\ 1 / {a}^{′} \cdot ( x - {c}^{′} ) = ( a / {a}^{′} ) \cdot cos θ & ( 16 )\end{matrix}$$

$$\begin{matrix}[ Equation 17 ] & \\ 1 / {b}^{′} \cdot ( y - {d}^{′} ) = ( b / {b}^{′} ) \cdot sin θ & ( 17 )\end{matrix}$$

Here, because a/a′=1 and b/b′=1 may be considered, the following expressions (18) and (19) are obtained.

$$\begin{matrix}[ Equation 18 ] & \\ 1 / {a}^{′} \cdot ( x - {c}^{′} ) = cos θ & ( 18 )\end{matrix}$$

$$\begin{matrix}[ Equation 19 ] & \\ 1 / {b}^{′} \cdot ( y - {d}^{′} ) = sin θ & ( 19 )\end{matrix}$$

Equations (18) and (19) illustrate a true circular orbit. That is, the distortion of the cosine wave and the sine wave can be calibrated, and the calibration unit 440 is capable of obtaining the cosine wave signal Cn3 (cos θ) and the sine wave signal Sn3 (sin θ) in which the distortion has been calibrated.

According to the first embodiment, the temperature characteristic of the ADC 330 can be canceled, the accuracy of the detected rotation angle can be improved, and the speed ripple can be reduced.

The constant of an ellipse can be extracted by capturing, as an ellipse, the locus of a sine wave signal and a cosine wave signal having distortion due to the temperature characteristic of the ADC 330. The distortion of the temperature characteristic of the ADC 330 can be invalidated by performing calibration based on the extracted constant, or so-called reverse correction, on both signals.

Because the first embodiment of the present invention is configured as described above, it is possible to implement a motor control device that is capable of executing calibration of the AD value of a general-purpose ADC even during driving of the motor, and of improving the detection accuracy of the rotational electrical angle of the motor.

### Second Embodiment

Next, a second embodiment of the present invention will be described.

FIG. 8 is an internal configuration diagram of a rotational-position detection unit 400 according to the second embodiment. The overall configuration of the motor control device 500 according to the second embodiment is similar to that in the first embodiment, and thus illustration and a detailed description thereof are omitted.

The difference between the rotational-position detection unit 400 according to the second embodiment and the rotational-position detection unit 40 according to the first embodiment is the internal structure of the buffer 410 and the elliptical approximation 430. In addition to the data stored in the array buffer unit 410 and the necessity result signal Sig1 from the calibration necessity determination unit 420, the sine wave signal Sn2 and the cosine wave signal Cn2 are inputted to the elliptical approximation unit 430 according to the second embodiment.

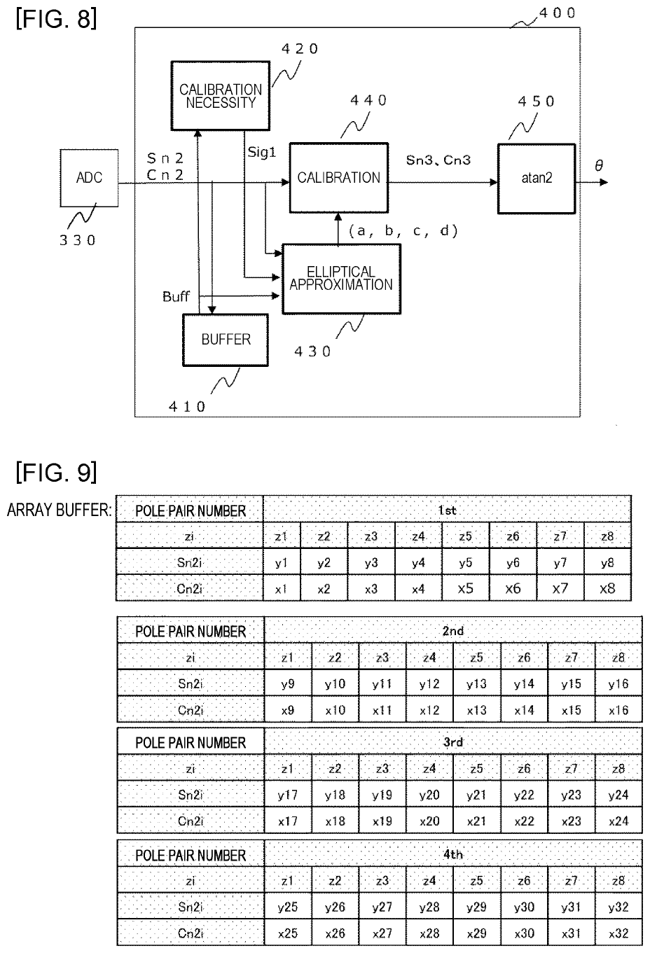

FIG. 9 is a diagram showing an arrangement configuration of data stored in an arrangement buffer 410 according to the second embodiment. In the second embodiment, a case where the number of pole pairs of the rotation sensor is four is taken as an example.

The elliptical approximation unit 430 collects the sets of data over one mechanical angle cycle after distinguishing the pole pair number of the rotation sensor (sets of data is collected through allocation to predetermined pole pair numbers over one mechanical angle cycle). In addition, the number of electrical angle zone divisions of each pole pair is eight. Because a case where the electric motor 300 rotates when the power supply of the motor control device 500 is off cannot be denied, the pole pair number when the power supply is turned on is set to 1st, and may be assigned as 2nd, 3rd, or 4th as the power supply is rotated forward.

Identification of a pole pair number is determined as the next pole pair number when x is around a maximum value and y changes from negative to positive. Alternatively, when, conversely, x is around the maximum value and y changes from positive to negative, the pole pair number is determined as the previous pole pair number.

When viewed from an electrical angle, because the sine wave signal Sn2 and the cosine wave signal Cn2 overlap the same orbit, the pole pair number cannot be identified. However, the processing shifts to the next pole pair number after always spanning an electrical angle of 360°E. The pole pair number can be identified by assigning the condition of spanning 360°E.

As described above, the sets of data (xi, yi) are collected in the same manner as in the first embodiment while dividing the number of pole pairs. The pole pair number at every moment is defined as pole pair information Np.

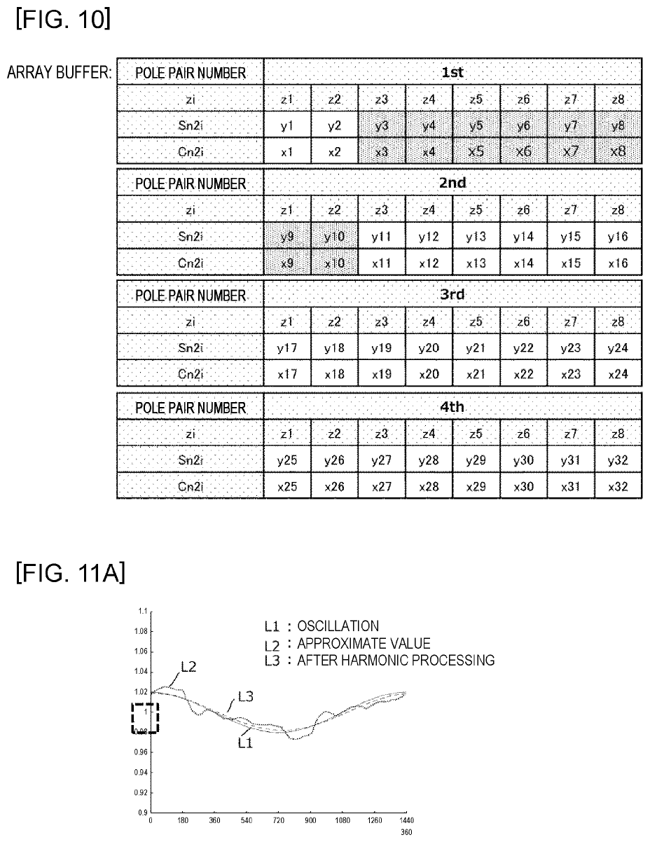

The operation of the elliptical approximation unit 430 according to the second embodiment will now be explained with reference to FIG. 10.

The relationship between a mechanical angle and an electrical angle can be expressed by the following expression (20) when the number of pole pairs is P.

$$Electrical angle = mechanical angle \times P \qquad ( 20 )$$

Data of consecutive 360° electrical angle widths is selected to perform elliptical approximation and to determine the constants (a′, b′, c′, d′). For example, FIG. 10 indicates that the eight sets of data ((x3, y3) to (x10, y10)) which are consecutive sets of data spanning the pole pair number 1st and the pole pair number 2nd have been selected. These are sets of data for an electrical angle width of 360° that enable elliptical approximation. Although an example with eight selected sets of data is shown, the number is not limited to eight, and an appropriate value from 8 to 16, for example, can be selected.

Mechanical angle information is assigned to the constants (a′, b′, c′, d′) obtained here. The electrical angle θ is then obtained by the motor rotation angle computation unit 450 via the calibration unit 440.

Note that 360° is added to the electrical angle of pole pair number 2nd, 360°×2 is added to the electrical angle of pole pair number 3rd, and 360°×3 is added to the electrical angle of pole pair number 4th. An average value θi of each electrical angle θ is obtained once, and the electrical angle is divided by the number of pole pairs P to determine a mechanical angle θmi as the elliptical constants (a′, b′, c′, d′).

The notation is (a′ (θmi), b′ (θmi), c′ (θmi), and d′ (θmi)) in order to highlight the positions.

The elliptical constants are extracted over one electrical angle cycle by switching between consecutive electrical angle widths of 360°.

That is, (a′ (θm1), b′ (θm1), c′ (θm1), and d′ (θm1)) are defined by (x1, y1)-(x8, y8); (a′ (θm2), b′ (θm2), c′ (θm2), and d′ (θm2)) are defined by (x2, y2)-(x9, y9); and (a′ (θm3), b′ (θm3), c′ (θm3), and d′ (θm3)) are defined by (x3, y3)-(x10, y10). Hereinafter, similarly, (a′ (θm32), b′ (θm32), c′ (θm32), and d′ (θm32)) are defined by (x32, y32)-(x7, y7).

As described above, it is possible to ascertain a series of elliptical constants (a, b, c′, d′) for the mechanical angle θm.

The elliptical approximation unit 430 is also capable of executing partial elliptical approximation by taking elliptical constant angle information as a mechanical angle average value which is used in the elliptical approximation, and thus of obtaining partial elliptical constants. A series of constants corresponding to the mechanical angle is defined by defining the individual mechanical angles of the partial elliptical constants. As a result, by determining the mechanical angle at each of the mechanical angle points, the constants can be connected to form a waveform.

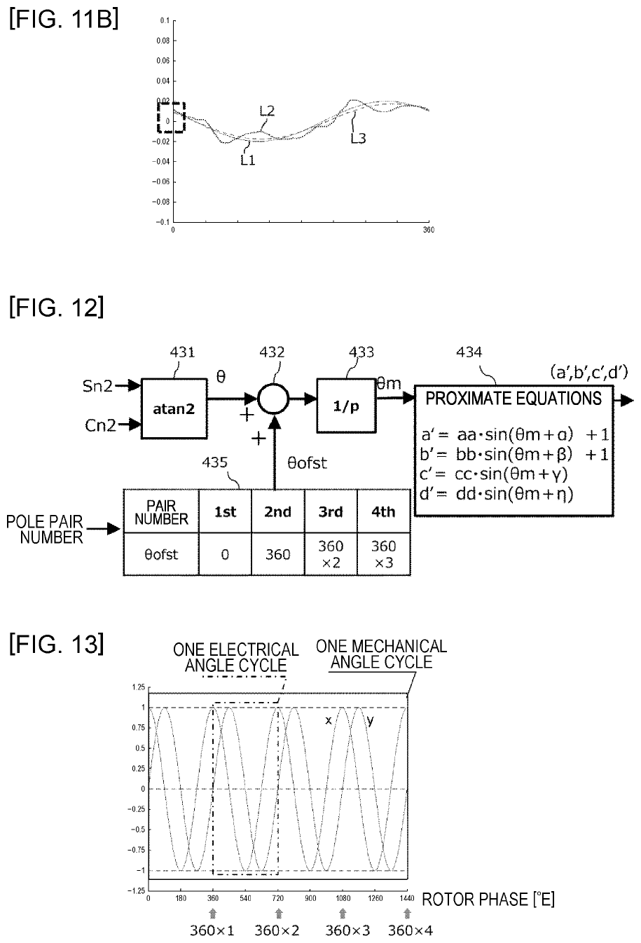

The dotted line L2 in FIG. 11A indicates a series (waveform line) of constant a′. The solid line L1 represents a series of constants a assumed at this time. For the dotted line L2, a waveform line shaped by harmonic processing is L3. Waveform line L3 after the harmonic processing is substantially equal to solid line L1 indicating the fluctuation.

FIG. 11B shows a series of constants b′. The solid line L1 represents the constant b assumed at this time.

For both constants a and b, a fluctuation of 2% was assumed. Although not illustrated, the constants c′ and d′ are also similar to each other.

As illustrated, the constants a′ and b′ include harmonics. This is because the gain and the offset move even while the electrical angle moves over a width of 360°, and because, for example, the start point and the end point do not coincide with each other.

Because a low-order wave can be ascertained, harmonic processing may be performed. Because the period is known as harmonic processing connecting constants, sin approximation (sine wave approximation) can be performed. By removing a harmonic signal, performing conversion into an approximation function that is easy to handle, and determining the mechanical angle for each of the mechanical angle points, the elliptical constants can be connected to form a waveform.

By executing the processing thus far, the constants aa, bb, cc, dd, α, β, γ, and η shown in the following expressions (21) to (24) are determined.

$${a}^{′} = aa \cdot sin ( θ m + α ) + 1 \qquad ( 21 )$$

$${b}^{′} = bb \cdot sin ( θ m + β ) + 1 \qquad ( 22 )$$

$${c}^{′} = cc \cdot sin ( θ m + γ \qquad ( 23 )$$

$${d}^{′} = dd \cdot sin ( θ m + η ) \qquad ( 24 )$$

FIG. 12 is a functional block diagram of an elliptical approximation unit 430 according to the second embodiment.

In FIG. 12, an a tan processing unit (arctangent processing unit) 431 calculates the electrical angle θ from the sine wave signal Sn2 and the cosine wave signal Cn2. The calculated electrical angle θ is outputted to an adder 432. Based on the pole pair information Np of the array buffer 410, the offset θofst is outputted from the offset table 435 to the adder 432.

The adder 432 then adds together the electrical angle θ and the offset θofst, supplies the result to a divider 433 for division by the number of pole pairs p to calculate the mechanical angle θm. Subsequently, a proximate equation processing unit 434 executes the expressions (21) to (24) above, and constants (a′, b′, c′, d′) for each moment are outputted to the calibration unit 440.

In addition to affording the same advantageous effects as those of the first embodiment, the second embodiment also makes it possible to calibrate fluctuations that occur over one mechanical angle cycle due to misalignment between the stator and the rotor of the sensor and inclination of the stator and the rotor.

### REFERENCE SIGNS LIST

100 motor drive device
110 current control unit
130 inverter
140 current sensor
160 excitation unit
200 battery
300 electric motor
320 resolver
330 ADC
400 rotational-position detection unit
410 array buffer
420 calibration necessity determination unit
430 elliptical approximation unit
431 a tan processing unit
432 adder
433 divider
434 proximate equation processing unit
435 offset table
440 calibration unit
440a, 440b multiplication/division calculator
440c, 440d subtractor
450 motor rotation angle computation unit (phase computation unit)
500 motor control device

1. A motor control device having:
a power conversion unit that converts DC power into three-phase AC power and outputs the converted three-phase AC power to a motor,
a rotation angle sensor that detects the phase of the motor, and
an AD converter that converts an analog signal outputted from the rotation angle sensor into a digital signal,
the motor control device comprising a rotational-position detection unit that includes:
a recording unit that records a plurality of sets of data which includes a sine wave signal and a cosine wave signal of the phase of the motor which are included in the digital signal;
a calibration necessity determination unit that determines, on the basis of the plurality of sets of data, whether or not calibration of the phase of the motor is required; and
an elliptical approximation unit that, in a case where calibration of the phase of the motor is required, performs elliptical approximation on the basis of the plurality of sets of data and calculates an elliptical constant;
a calibration unit that calibrates the sine wave signal and the cosine wave signal on the basis of the elliptical constant; and
a phase computation unit that computes the phase on the basis of the sine wave signal and the cosine wave signal calibrated by the calibration unit,
wherein the plurality of sets of data are distributed to a predetermined number of divided regions spanning one or more electrical angle cycles.

2. The motor control device according to claim 1,
wherein the plurality of sets of data are divided into at least eight regions spanning one electrical angle cycle.

3. The motor control device according to claim 2,
wherein, in the plurality of sets of data, a dividing line for dividing the one electrical angle cycle into at least eight regions is shifted by a predetermined angle from the x-axis and the y-axis.

4. The motor control device according to claim 3,
wherein the calibration necessity determination unit obtains the distance from an origin for each of the plurality of sets of data, and determines that calibration is required in a case where the difference between a maximum value and a minimum value for the distance from the origin exceeds a predetermined value.

5. The motor control device according to claim 4,
wherein the plurality of sets of data are allocated to predetermined pole pair numbers over one mechanical angle cycle, and
wherein the elliptical approximation unit identifies a pole pair number,
extracts a plurality of consecutive sets of data from the sets of data spanning the mechanical angle and performs partial elliptical approximation to obtain a partial elliptical constant,
slides the partial elliptical approximation to perform elliptical approximation spanning the entire mechanical angle, and
obtains connections between elliptical constants spanning the entire mechanical angle.

6. The motor control device according to claim 5,
wherein, when the cosine wave signal has a positive value,
the elliptical approximation unit advances the pole pair number to the positive rotation side given that the polarity of the sine wave signal has changed from a negative value to a positive value, and
conversely, the elliptical approximation unit advances the pole pair number to the reverse rotation side given that the sine wave signal has changed from a positive value to a negative value, and
performs identification of the pole pair number.

7. The motor control device according to claim 5,
wherein the elliptical approximation unit sets the consecutive number of extractions of the plurality of consecutive sets of data to at least eight.

8. The motor control device according to claim 5,
wherein the elliptical approximation unit obtains the partial elliptical constant by executing the partial elliptical approximation by using the angle information of the elliptical constant as an average value of the mechanical angles used for the elliptical approximation.

9. The motor control device according to claim 7,
wherein the elliptical approximation unit performs sine wave approximation on the connections between the elliptical constants.
